(19) United States
(12) Patent Application Publication
(10) Pub. No.: US 2005/0077498 A1
(43) Pub. Date: Apr. 14, 2005

(54) Polymerizable ion-conductive liquid-crystalline composite, anisotropically ion-conductive polymeric liquid-crystal composite, and process for producing the same

(76) Inventors: Takashi Kato, Kanagawa (JP); Kenji Kishimoto, Tokyo (JP); Hiroyuki Ohno, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/501,761

(22) PCT Filed: Jan. 22, 2003
(86) PCT No.: PCT/JP03/00555

(30) Foreign Application Priority Data
Jan. 22, 2002 (JP) 2002-13546

(51) Int. Cl. C09K 19/58; C09K 19/52

(52) U.S. Cl. 252/299.2; 252/299.01

(57) ABSTRACT

A composite of an organic monomer compound and an organic or inorganic salt, wherein the organic monomer compound comprises an ion-complexing moiety, a mesogen moiety that expresses a liquid crystalline phase and a polymerizable moiety in its molecular structure, is polymerized at the polymerizable moiety of the organic monomer compound, thereby forming an anisotropic ion-conductive polymeric liquid crystalline composite as a novel material having high ion conductivity characteristic of polymeric electrolytes, anisotropy due to orientation of a liquid crystal, and self-supporting properties characteristic of polymeric compounds.

### TECHNICAL FIELD

The present invention relates to a polymerizable ion-conductive liquid crystalline composite, an anisotropic ion-conductive polymeric liquid crystalline composite, and a process for producing the same. More specifically, the present invention relates to a novel anisotropic ion-conductive polymeric liquid crystalline substance having ion conductivity, liquid crystallinity, and self-supporting properties characteristic of polymeric compounds, which is useful in various industrial fields as a new electrolyte material, a battery material, a new material relating to substance transportation and reaction fields, a biomimetic material, and the like; the present invention also relates to a monomer compound for the production of said novel anisotropic ion-conductive polymeric liquid crystalline substance and a process for producing the same.

### BACKGROUND ART

Liquid crystal refers to an intermediate substance or state between solid and liquid, and is known as a functional material forming various structural orders in a self-organizing manner. Liquid crystals express various characteristics according to its anisotropy and dynamic properties. These characteristics are generally utilized in applications such as display materials, which make use of its optical properties and external field-responsiveness, and high-strength fibers, which make use of its orientation and fluidity. Furthermore, there are many examples of liquid crystallinity being introduced to other fibrous composite materials for the purpose of adding various functions.

On the other hand, some polymers are known to form polymer electrolytes exhibiting high metal ion conductivity or proton conductivity by incorporating metal salts or bronsted acids such as sulfonic acid and phosphoric acid (or functional groups thereof). Characteristics of such polymer electrolytes are as follows:
I) they complex with various ions;
II) they are light in weight; and
III) they become solids or elastic bodies even at temperatures greater than or equal to its glass transition temperature. Thus, in recent years, such electrolytes are actually being applied as lightweight materials for solid batteries to be loaded into portable electronic devices such as cell phones and notebook-size personal computers, that have come into wide use.

When liquid crystallinity is added to polymer electrolytes, formation of a material having anisotropic ion conductivity based on its order of orientation is to be expected. Thus, the inventors of the present application have synthesized a dimeric liquid crystalline compound wherein mesogen moieties are introduced into both terminus of poly(ethylene oxide) (PEO). Furthermore, it was also confirmed that by adding lithium salt to such compounds and uniformly orienting the resulting liquid crystalline composite, the composite exhibits an even two-dimensional ion conductivity. However, since these composites comprise compounds having a molecular weight of about 1000 or less, they exhibit fluidity. That is, they were problematic in that they needed to be enclosed in a cell or the like when used as materials. In order to utilize such composites as materials having self-supporting properties, mechanical strength may be added by, for example, converting them into polymers.

Indeed, polymeric ion conductors exhibiting liquid crystallinity have been reported. However, since uniform regulation of the orientation of a polymer is extremely difficult and uniform monodomain orientation as in the case of the dimeric liquid crystal developed by the present inventors cannot be obtained, in reality, most of such polymeric ion conductors do not exhibit uniform anisotropy regarding conductivity.

In such known ion-conductive polymeric liquid crystals, the polymeric liquid crystals are first synthesized and then complexed with a metal salt to express ion conductivity. Therefore, even when they exhibit properties derived from the microdomain structures of the liquid crystals, isotropic ion conductivity is only observed as bulk materials. Anisotropic ion conductivity measured for a main chain-type polymeric liquid crystal that is oriented in a magnetic field has been reported; however, a conductivity suitable for practical use has not obtained by such method.

Accordingly, the object of the present invention is to solve the above-mentioned problems of the prior art by providing a novel material that exhibits all of the following properties:
I) high ion conductivity characteristic of a polymer electrolyte;
II) anisotropy due to orientation of liquid crystal;
III) self-supporting properties characteristic of polymeric compounds.

### DISCLOSURE OF THE INVENTION

As a means to solve the above problems, the present invention firstly provides a polymerizable ion-conductive liquid crystalline composite, which comprises an organic monomer compound and an organic or inorganic salt complexed therewith, wherein the organic monomer compound contains, in its molecular structure, an ion-complexing moiety and a mesogen moiety that expresses liquid crystalline phase, along with a polymerizable moiety.

Further, the present invention provides, secondly, an anisotropic ion-conductive polymeric liquid crystalline composite, wherein the above polymerizable ion-conductive liquid crystalline composite is polymerized at the polymerizable moiety of the organic monomer compound; and thirdly, an anisotropic ion-conductive polymeric liquid crystalline composite, comprising in its molecular structure, a polymer structure-fixing moiety; an ion-complexing moiety; a mesogen moiety that express liquid crystalline phase; and an organic or inorganic salt, complexed therewith.

Furthermore, the present invention provides fourthly, a process for producing the anisotropic ion-conductive polymeric liquid crystalline composite of the above-described second or third aspect of the invention, which comprises: polymerizing a composite of an organic monomer compound and an organic or inorganic salt, wherein the composite contains an ion-complexing moiety and a mesogen moiety that express liquid crystalline phase, along with a polymerizable moiety; and fifthly, the process for producing the anisotropic ion-conductive polymeric liquid crystalline composite, wherein the composite is polymerized by light-irradiation or heating.

### BRIEF DESCRIPTION OF DRAWINGS

FIG. 1 is a scheme that illustrates a cell for measuring ion conductivity.

FIG. 2 is a scheme that illustrates a cell other than that in FIG. 1.

FIG. 3 shows a SEM photograph.

FIG. 4 is a graph exemplifying measured results of ion conductivity.

### BEST MODE FOR CARRYING OUT THE INVENTION

The present invention has the above-mentioned characteristics; hereinafter, their embodiments are described.

In particular, the present invention provides a novel anisotropic ion-conductive polymeric liquid crystalline composite as a novel material having all of the following properties:
I) high ion conductivity characteristic of polymer electrolytes;
II) anisotropy due to orientation of liquid crystals; and
III) self-supporting properties characteristic of polymeric compounds.

One means for realizing such a novel anisotropic ion-conductive polymeric liquid crystalline composite is by using the novel polymerizable ion-conductive liquid crystalline composite provided as a precursor by the present invention. It comprises:
<A> an organic monomer compound having, in its molecular structure, an ion-complexing moiety and a mesogen moiety that expresses a liquid crystalline phase, along with a polymerizable moiety; and
<B> an organic or inorganic salt. Examples of the molecular structure of the organic monomer compound <A> may be outlined as follows:

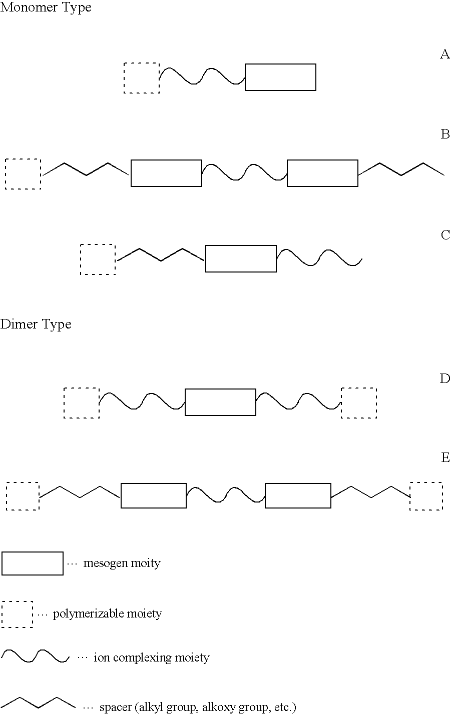

Monomer type or a dimer type compounds may be considered. In the after-mentioned Example section, type (A) monomers are used.

Further, as the moiety that complex with an ion, oligo(oxyalkylene)s and various structures such as the following may be used.

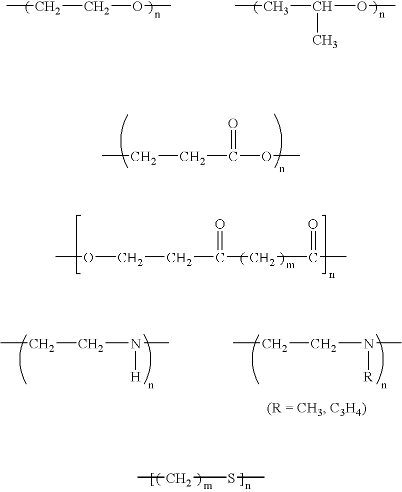

Moreover, a polymerizing group in the polymerizable moiety, may be selected from, for example, the following structures:

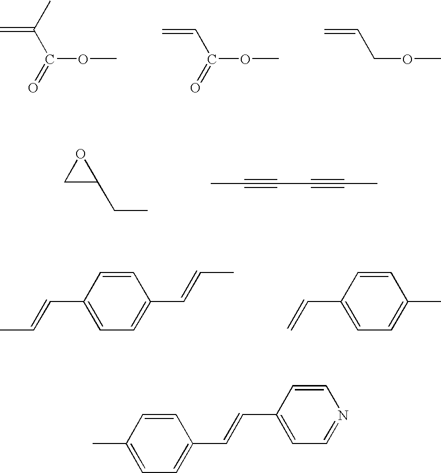

Furthermore, regarding the mesogen moiety that expresses a liquid crystalline phase, either of the following general structure:
(1)-ring(lateral substituent)-ring(side chain terminal group)
(2)-ring(lateral substituent)-linking group-ring(side chain terminal group)
   may be exemplified. In such cases, the ring structure may be, for example, those represented by the following formulae: 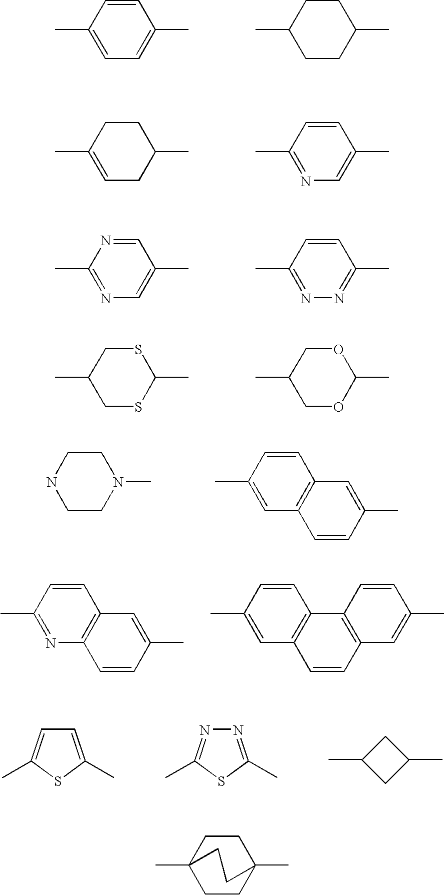
   when a linking group is present, it may be any type including, for example, those represented by the following formulae:

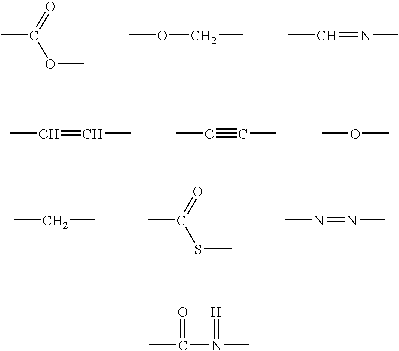

When one or more lateral substituents are present in the ring, they may be any group selected from: halogen atoms such as F, Cl, and Br; alkyl groups such as methyl and ethyl groups; alkoxy groups such as methoxy and ethoxy groups; hydroxyl group; cyano group; nitro group; and the like. The side chain terminal group attached to the ring may be any group selected from, for example, alkyl groups, alkoxy groups, cyano group, nitro group, and the like.

For example, an arbitrary combination of the above-described elements that constitute the mesogen moiety may be selected. Examples of such combinations of elements are as follows:

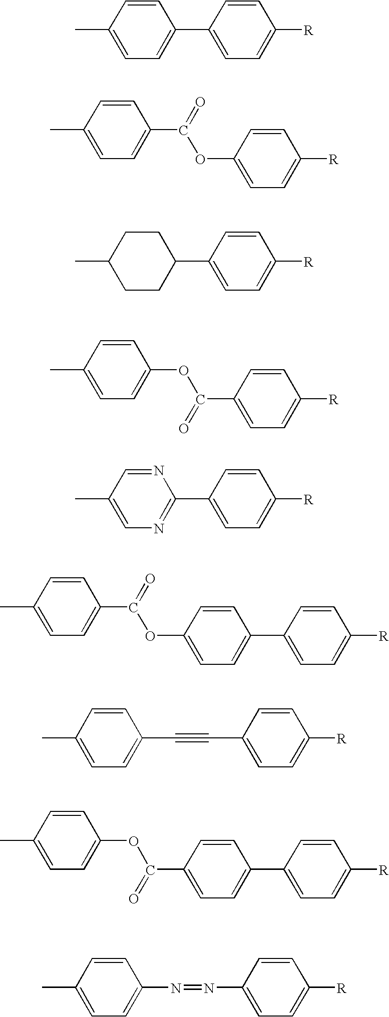

Furthermore, the following structures may also be exemplified.

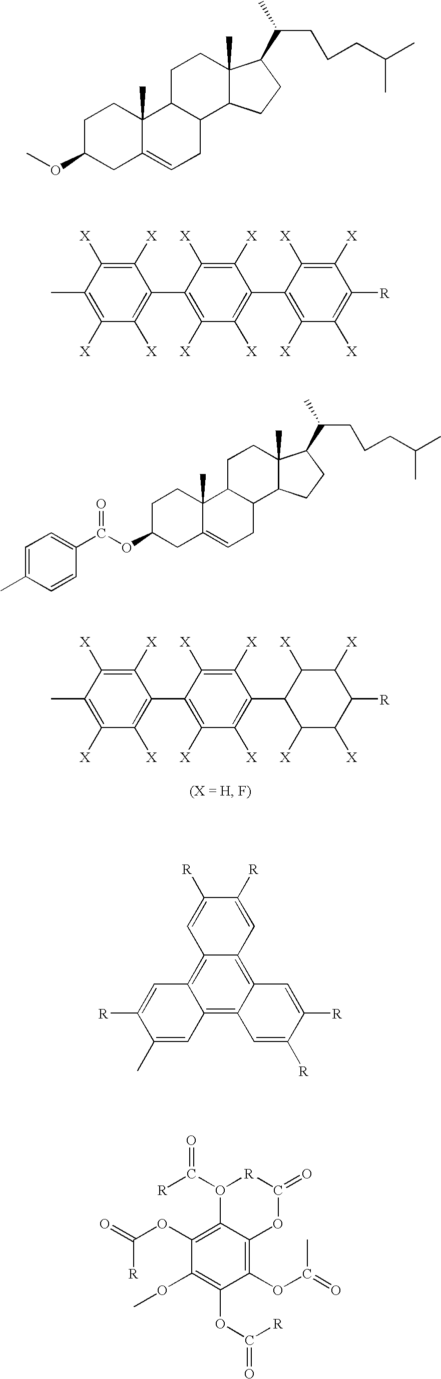

In any of the above cases, the symbol R represents, for example, an alkyl group, an alkoxy group, a cyano group, or a nitro group, and the symbol X represents, for example, a hydrogen atom or a halogen atom such as F.

The organic or inorganic salt (MX) <B> that is complexed with the above-described organic monomer compound <A>, may consist of the following cation species (M⁺) and anion species (X⁻).

| | | |
|---|---|---|
| Cation species (M⁺): | Li⁺, Na⁺, K⁺, Mg²⁺, Ca²⁺, Sc³⁺, | 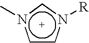 |
| Anion species (X⁻): | CF₃SO₃⁻, ClO₄₋, AlCl_{4-, SCN}⁻, AsF₆₋, BF₄₋, PF₆₋ | |

Of course, such salts are not limited to these examples.

For example, the composite of the above-mentioned organic monomer compound <A> and the above-mentioned organic or inorganic salt <B> can be easily produced by mixing the two components.

In this case, the mixing may be achieved by melting both components <A> and <B> or, if difficult to melt, by heating them or by dissolving them in an organic solvent and evaporating the solvent. The mixing ratio of components <A> and <B> may be arbitrarily determined in accordance with the type of components selected or the combination thereof. For example, the molar ratio of the cation species in component <B> to the unit of the ion-complexing moiety in component <A>, e.g. the oxyalkylene unit in oligooxyalkylene, may be 1 or less, and more preferably, 0.8 or less.

Further, by using such organic monomer composite, the ion-conductive polymeric liquid crystalline composite of the present invention, which enables the realization of anisotropic ion-conductive films and the like, is provided. The structure comprises:
I) an ion-complexing moiety that complexes with an ion;
II) a mesogen moiety that expresses a liquid crystal phase;
III) a polymer structure that fixes the structure; and
IV) an organic or inorganic salt.

Hitherto, the preparation of materials that exhibit both anisotropy characteristic of liquid crystal and self-supporting properties characteristic of polymer, without losing either of such properties, and materials that exhibit further functions, were considered to be difficult. However, in the present invention, the preparation is enabled by the “in situ polymerization” of a low molecular weight monomer, namely, a composite of <A> and <B>. Polymerization may be performed by light-irradiation or heating.

“In situ polymerization” such as photopolymerization, is an extremely useful means for fixing a polymerizable molecule while maintaining its structural order, and has been applied to fix various functional monomers including liquid crystals. Thus, it is effective to utilize the procedure of this “in situ polymerization”. After controlling the orientation of the composite comprising a polymerizable liquid crystalline monomer and an organic salt or an inorganic salt, which exhibits ion conductivity as mentioned above, “in situ polymerization” may be carried out, whereby self-supporting properties are added while maintaining anisotropic structure. The thus obtained composite of a polymeric liquid crystal and an organic or inorganic salt exhibits conductivity that reflects the structural order of the composite prior to polymerization. So far, there has been no report of actively utilizing the structural order achieved in the liquid crystalline monomer stage through in situ polymerization for the preparation of ion-conductive liquid crystalline materials. The ion-conductive polymeric liquid crystal prepared by this method expresses electric properties, optical properties, and the like that could not be achieved until now. Of course, for a composite consisting of a suitable combination of the above-described elements, a similar material may also be prepared by thermal polymerization.

Needless to say, various conditions for polymerization, e.g., wavelength of light, heating temperature, etc. may be suitably chosen taking into account the molecular structure of the precursor monomer that is to be polymerized.

For example, when a radical is used as a trigger for the polymerization reaction, the reaction should preferably be performed under an oxygen-free condition. Therefore, an inert atmosphere such as argon or nitrogen may be considered. In this case, the reaction temperature is preferably between room temperature and 80° C.

On the other hand, in photopolymerization other than photo radical polymerization, a polymerizing group that is stable against heat may be present.

An example of such a case is when an epoxy group, an allyl ether group, or the like is present. Taking these factors into account, in photopolymerization, the reaction temperature should preferably be in a range up to about 100° C.

For photopolymerization, as mentioned above, a radical may be used as a trigger; an example of such a case is where component <A> is a methacrylate monomer. For the efficient generation of radicals, a photo radical initiator (generator) may be added to the reaction system.

Regarding other polymerizing groups, the use of photo cation initiators and metal complex initiators may be considered for groups that undergo cationic polymerization (e.g., allyl ether, etc.) and groups that undergo coordination polymerization (e.g., phenylacetylene group), respectively.

Examples of initiators and irradiation wavelengths are listed bellow:

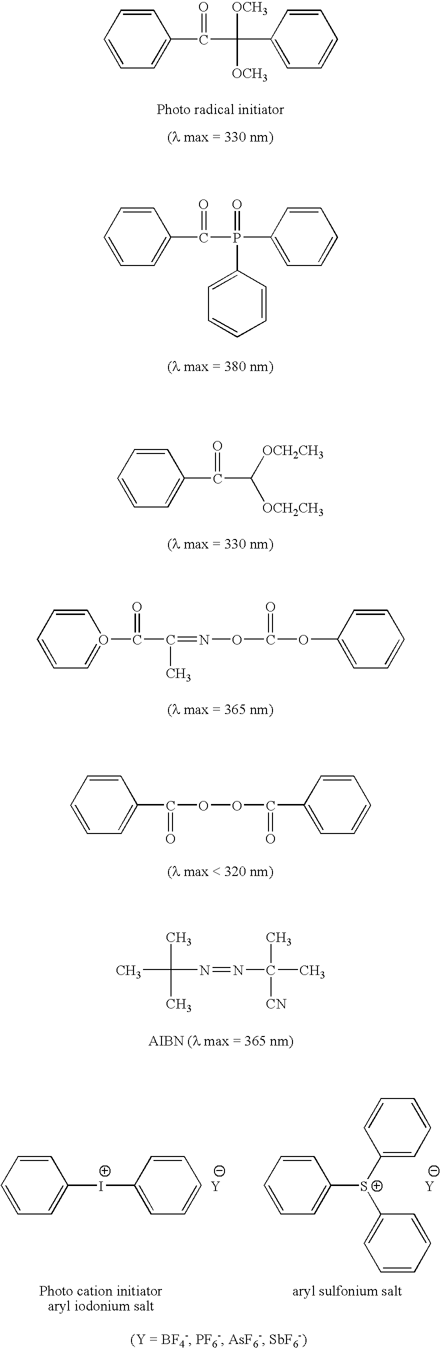

Metal complex initiator
W(CO)₆, MO(CO)₆

Moreover, it should be needless to say that the polymerization may be carried out in a predetermined cell and may be accompanied by shaping into a predetermined form such as a film or a sheet.

With regard to the ion-conductive polymeric liquid crystalline composite provided by the present invention, the following applications may be considered:
electronic devices and battery materials;
nano-technology;
patterning materials;
coating materials having specific electric properties; and
bio-covering materials such as ion channel.

The present invention will be described in further detail with reference to the following Examples. Of course, the invention is not limited by the following examples.

### EXAMPLES

### Example 1

As an ion-conductive liquid crystalline monofunctional monomer compound, the following compound (1) was synthesized.

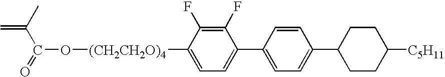

The reactions for the synthesis were carried out according to the following reaction scheme.

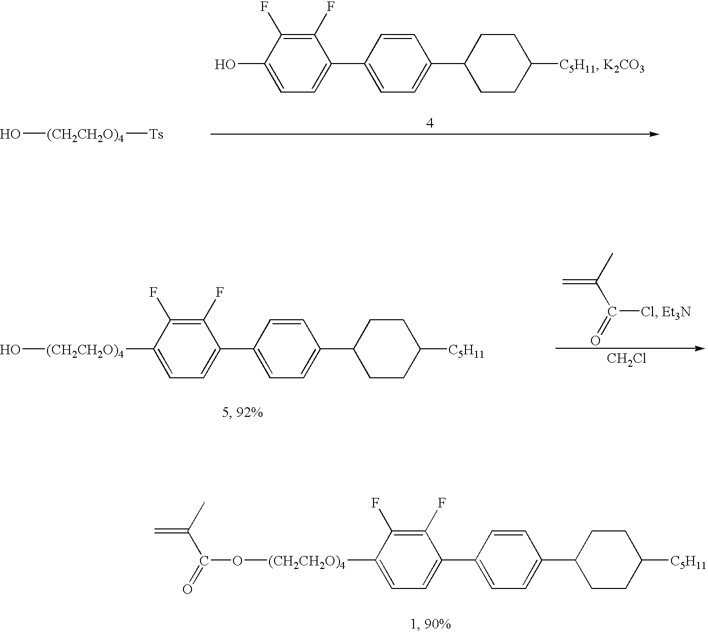

### <A> Synthesis of 2-(2-[2-{2-(2,3-difluoro-4-{4-(4-trans-pentylcyclohexyl)phenyl}phenoxy)ethoxy}ethoxy]ethoxy)ethanol (Compound 5)

To a two-neck 100 mL flask containing a magnetic stirrer are added tetraethylene glycol monotosylate (Mw=348, 0.809 g, 2.89 mmol), a separately synthesized liquid crystalline mesogen compound 4 (Mw=358, 1.01 g, 2.81 mmol), potassium carbonate (Mw=138, 1.15 g, 8.33. mmol), and dimethylformamide (10 mL), and the whole is stirred under an argon atmosphere in an oil bath (0° C.) for 24 hours. After confirming the completion of the reaction by thin-layer chromatography (TLC), ethyl acetate (100 mL) and water (100 mL) are added to the reaction solution to extract the organic layer; then, the aqueous layer is extracted with ethyl acetate (50 mL). The combined organic layer is washed with 5% hydrochloric acid aqueous solution (100 mL), further washed with water (100 mL), and then washed with a supersaturated sodium chloride aqueous solution (100 mL). Subsequently, after drying by addition of magnesium sulfate and filtration, the solvent is removed by evaporation under reduced pressure using a rotary evaporator. The residue is purified by flash silica column chromatography using ethyl acetate as a developing solvent to obtain a white waxy compound 5 (Mw=535, 1.15 g, 2.15 mmol: yield 92%).

The physical properties of this compound were as follows:

TABLE 1
¹H NMR(CDCl₃, 400MHz): δ=0.90(t, J=6.84Hz, 3H), 1.02-1.10(m, 2H),
1.20-1.34(m, 9H), 1.42-1.53(m, 2H), 1.90(t, J=13.2Hz, 4H), 2.47-2.53(m,
1H), 2.64(s, 1H), 3.60-3.62(m, 2H), 3.65-3.77(m, 10H), 3.90(t,
J=4.88Hz, 2H), 4.24(t, J=4.88Hz, 2H), 6.80-6.84(m, 1H),
7.06-7.11(m, 1H), 7.27(d, J=8.30Hz, 2H), 7.42(d, J=7.81Hz, 2H)
¹³C NMR(CDCl₃, 100MHz), δ=14.07(S), 22.66(S), 26.59(S),
32.15(S), 33.51(S), 34.22(S), 37.23(S), 37.32(S),
44.27(S), 61.64(S), 69.39(S), 69.47(S), 70.25(S), 70.50(S),
70.58(S), 70.87(S), 72.43(S), 109.93(d,
J=2.28Hz), 123.38(S), 123.47(dd, J=4.13, 4.13Hz), 126.98(S), 128.53
(d, J=3.10Hz), 132.17(dd, J=1.45, 2.28Hz), 141.81(dd, J=15.1, 247.7Hz),
147.15(dd, J=2.89, 8.27Hz), 147.41(S), 148.74(dd, J=11.1, 248.6Hz)

### <B> Synthesis of 2-(2-[2-{2-(2,3-difluoro-4-{4-(4-trans-pentyl cyclohexyl)phenyl}phenoxy)ethoxy}ethoxy]ethoxy)ethanol monomethacrylate (Compound 1)

To a two-neck 50 mL flask containing a magnetic stirrer are added compound 5 (Mw=535, 646 mg), triethylamine (0.5 mL), 2,6-di-tert-butylphenol (1.00 mg, 4.85×10⁻³ mmol), and methylene chloride (7 mL), and the whole is dipped in an ice bath (0° C.) and shielded from light. Next, methacryloyl chloride (0.20 mL, d=1.08 g/cm²) is slowly added dropwise to the solution using a syringe and the whole is stirred further in the ice bath for 3 hours. After confirmation of the completion of the reaction by TLC, chloroform (30 mL) and water (30 mL) are added to the reaction solution to extract the organic layer and then the aqueous layer is extracted with chloroform (50 mL). The combined organic layer is washed with a supersaturated ammonium chloride aqueous solution (100 mL), further washed with water (100 mL), and then washed with a supersaturated sodium chloride aqueous solution (100 mL). Subsequently, after drying by addition of magnesium sulfate and filtration, the solvent is removed by evaporation under reduced pressure using a rotary evaporator. The residue is purified by flash silica column chromatography using methylene chloride as a developing solvent to obtain a white waxy compound 1 (Mw=603, 662 mg, 1.10 mmol: yield 90%).

Physical properties of this compound were as follows:

TABLE 2
¹H NMR(CDCl₃, 400MHz): δ=0.90(t, J=6.84, 3H),
1.01-1.11(m, 2H), 1.20-1.34(m, 9H), 1.42-1.53(m, 2H), 1.78-1.97(m,
7H), 2.47-2.54(m, 1H), 3.64-3.75(m, 10H), 3.89(t, J=4.64, 2H),
4.24(t, J=4.88, 2H), 4.30(t, J=4.88, 2H), 5.56(t, J=1.47, 1H),
6.13(s, 1H), 6.79-6.83(m, 1H), 7.06-7.11
(m, 1H), 7.27(d, J=8.31, 2H), 7.42(d, J=8.06, 2H).
¹³C NMR(CDCl₃, 100MHz), δ=14.08(S), 18.26(S),
22.67(S), 26.60(S), 32.16(S), 33.51(S), 34.22(S), 37.23(S),
37.32(S), 44.28(S), 63.83(S), 69.07(S), 69.40(S), 69.49(S),
70.9(S), 70.60(S), 70.62(S), 70.92(S), 109.92(S), 123.36(S),
123.46(dd, J=4.14, 4.14Hz), 125.61(S), 126.99(S),
128.53(d, J=2.69Hz), 132.18(S), 136.08(S), 141.81(dd,
J=15.1, 247.7Hz), 117.18(dd, J=3.10, 8.27Hz), 147.42(S),
148.75(dd, J=10.9, 248.1Hz), 167.29(S).

### Example 2

Through observation with polarizing microscope and DSC measurement, it was confirmed that the polymerizable liquid crystalline monomer compound (1) obtained in Example 1, in which the oligo(oxyethylene) moiety is complexed with an ion to form an ion-conductive moiety realized a smectic liquid crystalline phase at room temperature (Table 3). When a lithium salt (2) was incorporated as a salt that carries ion conductivity, thermal stability of the smectic liquid crystal was improved (10° C.). This improvement may be attributed to the ion-dipole interaction between the lithium ion and the oxyethylene moiety. Further, a composite (1/2/3) was prepared by adding compound (3) in an amount of 0.5 wt % relative to compound (1), but no significant change of the liquid phase was observed by the addition.

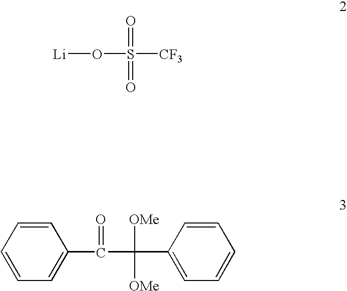

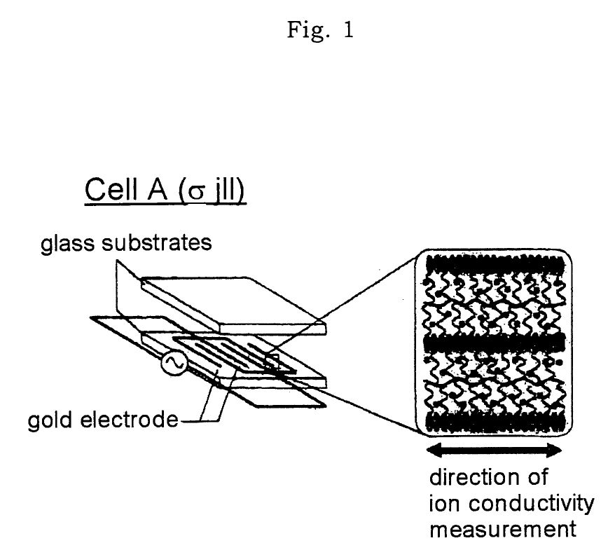

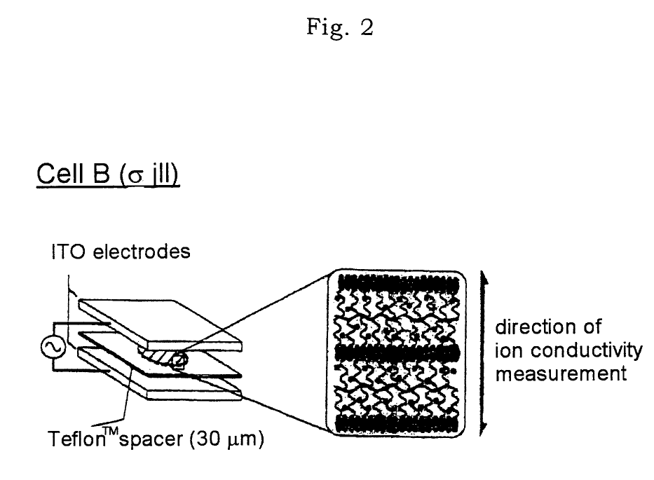

Then, this (1/2/3) was enclosed in two types of cells shown in FIGS. 1 and 2 (cell A: a glass substrate with a comb-shaped gold electrode; cell B: an ITO glass electrode) for measuring ion conductivity. The conoscope image of (1/2/3) exhibited a cross image. This result suggests that (1/2/3) shows homeotropic orientation, wherein the long axis of the molecule stood vertical to each substrate.

The sample enclosed in each cell was irradiated with ultraviolet light (35 mW/cm) adjusted to around 365 nm for 30 minutes to obtain Poly-(1/2/3).

The sample enclosed in each cell was irradiated with ultraviolet light (35 mW/cm) adjusted to around 365 nm for 30 minutes to obtain a poly-(1/2/3). When the polymerized sample was observed with a polarizing microscope, a remarkable change was observed in the phase-transition behavior; as shown in Table 3, the clearing point was elevated by about 130° C., indicating that the liquid crystalline phase was greatly stabilized by the polymerization reaction. Moreover, the results of IR measurement indicated that the peaks at 880 cm⁻¹ (out-of-plane stretching vibration of C═CH₂), 1170 cm⁻¹ (stretching vibration between C—O of C═C—COOR), and the like disappeared after polymerization. The disappearance of NMR peaks (δ=5.56, 6.13) corresponding to the double bond suggested that the reaction rate was about 93% based. Based on these findings, it was confirmed that the polymerization reaction proceeded. Moreover, through conoscope observation, it was found that the sample after irradiation maintained the uniform vertical orientation.

TABLE 3
Phase transition behavior of liquid crystalline compound
(at 2nd cooling)

| Compound | Phase transition temperature (° C.) | | | | | | |
|---|---|---|---|---|---|---|---|
| 1 | G-64 | | S_{B} | 9 | SA | 46 | Iso |
| 1/2 | G-54 | | S_{B} | 0 | SA | 54 | Iso |
| poly-(1/2/3) | G-11 | M₁ 92 | M₂ | 132 | SA | 182 | Iso |

1/2; [Li]/[CH₂CH₂O] = 0.05, Poly-(1/2/3); 1/2/3 after polymerization (1:3 = 200:1 (weight ratio))
G; glass state, M₁, M₂; high-order smectic phases, S_{A}; smectic A phase, S_{B}; smectic B phase, Iso; isotropic phase.

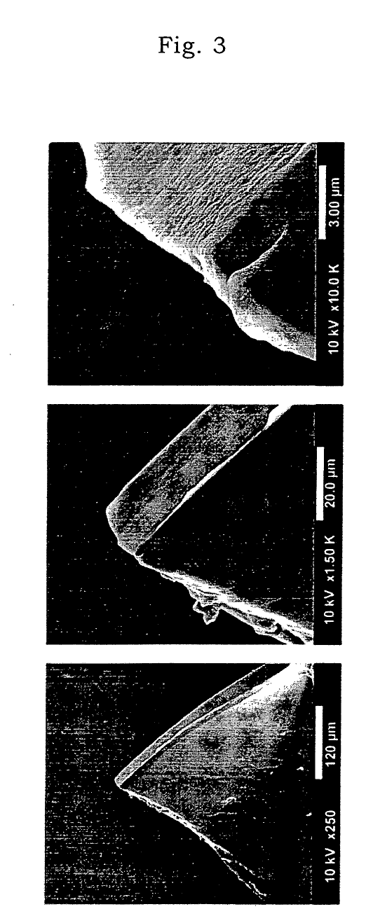

When the resulting film-form solid was observed using an ultrahigh-resolution SEM (FIG. 3), it was found that the solid had an extremely uniform lamellar structure. Although some SEM images reflecting structures of liquid crystalline phase have been reported for cases where monomers exhibiting nematic liquid crystalline phase or monomers exhibiting cholesteric liquid crystalline phases were subjected to photopolymerization to fix the structural order, a system reflecting a lamellar structure of a smectic liquid crystal, as in the present case, is extremely rare. Thus, it was found that the nano-level structural order of the molecules were reflected in the micrometer order and the macroscopic order. Such structural order also suggests that the film-form solid is likely to exhibit anisotropic ion conductivity.

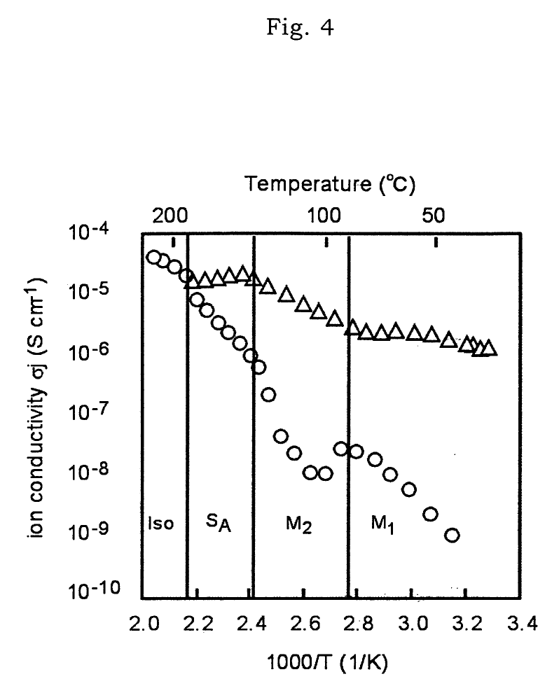

Next, the ion conductivity of the poly-(1/2/3) prepared in each cell was measured using an AC impedance method. The ion conductivity in cell A was measured in a direction horizontal to the smectic layer (A), while in cell B, it was measured in a direction vertical to the smectic layer (O); the results are shown in FIG. 4. From these results, it was found that ion conductivity in the direction horizontal to the layer was about 1000 times higher than the conductivity in the vertical direction. Moreover, the behavior of the conductivity remarkably changed at the phase transition temperature shown in Table 3, which was found to correspond to the change in the liquid crystalline phase.

As described above, with regard to the film-form solid prepared in this example, it was confirmed that a polymeric liquid crystalline material was obtained by fixing the structural order prior to polymerization of the liquid crystalline composite.

### Example 3

As an ion-conductive monomer, the following compound (6) was synthesized. This compound corresponds to the above monomer type C.

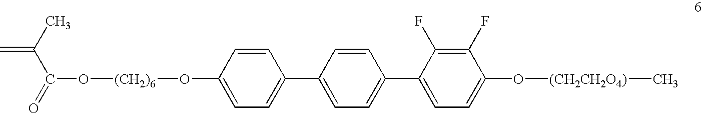

The reactions for the synthesis were carried out according to the following scheme. 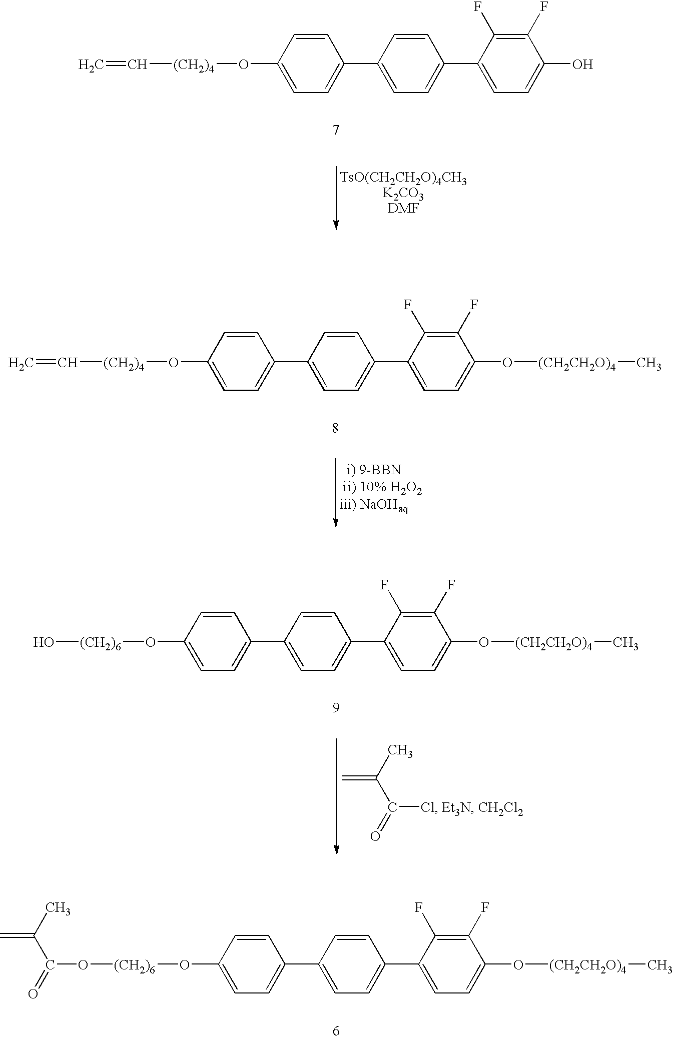
Synthesis of Compound 8

To a two-neck 100 mL flask containing a magnetic stirrer are added α-methyl-ω-tosyltetraethylene glycol (Mw=362, 220 mg, 0.107 mmol), a liquid crystalline mesogen compound (7) (Mw=380, 260 mg, 0.684 mmol) synthesized separately, potassium carbonate (Mw=138, 280 mg, 2.03 mmol), and dimethylformamide (5 mL), and the whole is stirred under an argon atmosphere in an oil bath (80° C.) for 24 hours. After confirming the completion of the reaction by thin-layer chromatography (TLC), ethyl acetate (100 mL) and water (100 mL) are added to the reaction solution to extract the organic layer and then the aqueous layer is extracted with ethyl acetate (50 mL). The combined organic layer is washed with 5% hydrochloric acid aqueous solution (100 mL), further washed with water (100 mL), and then washed with a supersaturated sodium chloride aqueous solution (100 mL). Subsequently, after drying by addition of magnesium sulfate and filtration, the solvent is removed by evaporation under reduced pressure using a rotary evaporator. The residue is purified by flash silica column chromatography using ethyl acetate as a developing solvent to obtain a white waxy compound (8) (Mw=571, 332 mg, 0.581 mmol: yield 94%).

TABLE 4

¹H NMR(CDCl₃, 400MHz): δ=1.56-167(m, 2H),
1.80-1.88(m, 2H), 2.12-2.18 (m, 2H), 3.38(s, 3H),
3.53-3.77(m, 12H), 3.91(t, J=4.88, 2H), 4.02
(t, J=6.35, 2H), 4.26(t, J=4.88, 2H), 4.97-5.08(m, 2H),
5.80-5.90(m, 1H), 6.83-6.87(m, 1H), 6.83-6.87(m, 1H),
6.99(d, J=8.88, 2H), 7.12-7.16(m, 1H), 7.55-7.64(m, 6H).

Synthesis of Compound 9

In a two-neck 50 mL flask containing a magnetic stirrer is placed the above compound (8) (Mw=571, 326 mg, 0.571 mmol) as a solution of dried tetrahydrofuran (THF) (2 mL), and the whole is cooled in an ice bath. A 0.5M THF solution (2.3 mL) of 9-borabicyclo[3.3.1]nonane is slowly added to the solution dropwise using a syringe. After the dropwise addition, the solution is slowly warmed to room temperature and then stirred for 24 hours. After confirmation of addition of 9-borabicyclo[3.3.1]nonane by TLC, a small amount of water is added. Further, 3N NaOH_{aq} (0.57 mL) is added thereto, followed by stirring at room temperature for 6 hours. After confirming the completion of the reaction by TLC, ethyl acetate (100 mL) and water (100 mL) are added to the reaction solution to extract the organic layer and then the aqueous layer is extracted with ethyl acetate (50 mL). The combined organic layer is washed with 5% hydrochloric acid aqueous solution (100 mL), further washed with water (100 mL), and then washed with a supersaturated sodium chloride aqueous solution (100 mL). Subsequently, after drying by addition of magnesium sulfate and filtration, the solvent is removed by evaporation under reduced pressure using a rotary evaporator. The residue is purified by flash silica column chromatography using a mixed solvent of hexane and ethyl acetate (hexane:ethyl acetate=1:10) as the developing solvent to obtain a white waxy compound (9) (Mw=589, 144 mg, 0.273 mmol: yield 48%).

TABLE 5

¹H NMR(CDCl₃, 400MHz): δ=1.46-1.64(m, 6H),
1.80-1.88(m, 2H), 3.38(s, 3H), 3.54-3.77(m, 14H), 3.91(t,
J=4.88, 2H), 4.02(t, J=6.35, 2H), 4.26(t, J=4.88, 2H),
6.83-6.86(m, 1H), 6.98(d, J=8.78, 2H), 7.12-7.17(m, 1H),
7.55-7.64(m, 6H).

Synthesis of Compound 6

To a two-neck 50 mL flask containing a magnetic stirrer is added compound (9) (Mw=589, 161 mg, 0.273 mmol), triethylamine (0.2 mL), 2,6-di-tert-butylphenol (Mw=206, 1.00 mg, 4.85×10⁻³ mmol), and methylene chloride (5 mL), and the whole is dipped in an ice bath (0° C.) and shielded from light. Next, methacryloyl chloride (0.1 mL, d=1.08 g/cm²) is slowly added to the solution dropwise using a syringe and the whole is stirred further in the ice bath for 3 hours. After confirming the completion of the reaction by TLC, chloroform (30 mL) and water (30 mL) are added to the reaction solution to extract the organic layer and then the aqueous layer is extracted with chloroform (50 mL). The combined organic layer is washed with a supersaturated ammonium chloride aqueous solution (100 mL), further washed with water (100 mL), and then washed with a supersaturated sodium chloride aqueous solution (100 mL). Subsequently, after drying by addition of magnesium sulfate and filtration, the solvent is removed by evaporation under reduced pressure using a rotary evaporator. The residue is purified by flash silica column chromatography using ethyl acetate as a developing solvent to obtain a white waxy compound (6) (Mw=657, 78.3 mg, 0.119 mmol: yield 44%).

TABLE 6

¹H NMR(CDCl₃, 400MHz): δ=1.48-1.95(m, 11H),
3.38(s, 3H), 3.54-3.78(m, 12H), 3.92(t, J=4.64, 2H), 4.02(t,
J=6.35, 2H), 4.17(t, J=6.59, 2H), 4.26(t, J=4.88, 2H),
5.56(s, 1H), 6.11(s, 1H), 6.83-6.87(m, 1H), 6.98(d, J=8.79,
2H), 7.12-7.17(m, 1H), 7.27-7.58(m, 4H), 7.63(d, J=8.79, 2H).

Liquid Crystallinity of Compound (6) and Complexing with Lithium Salt

Compound (6) is a polymerizable liquid crystalline monomer compound wherein the polymerizing moiety is bonded to the terminal opposite to the oligoethylene moiety. Compound (6) expressed a smectic C phase from room temperature to 64° C. (temperature-elevating process). When a lithium salt (compound 2) was added thereto ([Li]/[CH₂CH₂O]=0.05), the resulting composite exhibited a smectic C phase from room temperature to 46° C. and subsequently exhibited a smectic A phase up to 71° C. (temperature-elevating process).

When the composite was placed between two glass substrates, and observed by a polarizing microscope, it was revealed that a vertical orientation uniformly formed in the smectic A phase. Compound 3 was added (0.5 wt %) to the uniformly oriented composite and the composite was fixed by photopolymerization in the same manner as in Example 2 to form a transparent polymer film (Poly-(6/2/3)).

### Industrial Applicability

As described in detail above, the present invention provides a novel anisotropic ion-conductive polymeric liquid crystalline composite that exhibit high ion conductivity characteristic of polymeric electrolytes, anisotropy due to orientation of a liquid crystal, and self-supporting properties characteristic of polymeric compounds.

1. A polymerizable ion-conductive liquid crystalline composite, which comprises an organic monomer compound and an organic or inorganic salt complexed therewith, wherein the organic monomer compound contains, in its molecular structure, an ion-complexing moiety and a mesogen moiety that expresses liquid crystalline phase, along with a polymerizable moiety.

2. An anisotropic ion-conductive polymeric liquid crystalline composite, wherein the polymerizable ion-conductive liquid crystalline composite of claim 1 is polymerized at the polymerizable moiety of the organic monomer compound.

3. An anisotropic ion-conductive polymeric liquid crystalline composite, comprising in its molecular structure,
a polymer structure-fixing moiety;
an ion-complexing moiety;
a mesogen moiety that express liquid crystalline phase; and
an organic or inorganic salt, complexed therewith.

4. A process for producing the anisotropic ion-conductive polymeric liquid crystalline composite of claim 2, which comprises:
polymerizing a composite of an organic monomer compound and an organic or inorganic salt, wherein the composite contains an ion-complexing moiety and a mesogen moiety that express liquid crystalline phase, along with a polymerizable moiety.

5. The process for producing the anisotropic ion-conductive polymeric liquid crystalline composite of claim 4, wherein the composite is polymerized by light-irradiation or heating.

6. A process for producing the anisotropic ion-conductive polymeric liquid crystalline composite of claim 3, which comprises:
polymerizing a composite of an organic monomer compound and an organic or inorganic salt, wherein the composite contains an ion-complexing moiety and a mesogen moiety that express liquid crystalline phase, along with a polymerizable moiety.

7. The process for producing the anisotropic ion-conductive polymeric liquid crystalline composite of claim 6, wherein the composite is polymerized by light-irradiation or heating.
